(19) United States
(12) Patent Application Publication
(10) Pub. No.: US 2012/0239222 A1
(43) Pub. Date: Sep. 20, 2012

(54) CONTROL DEVICE FOR A MOTOR VEHICLE

(75) Inventors: Michael KECKEISEN, Meckenbeuren (DE); Michael AMANN, Tettnang (DE)

(73) Assignee: ZF FRIEDRICHSHAFEN AG, Friedrichshafen (DE)

(21) Appl. No.: 13/419,656

(22) Filed: Mar. 14, 2012

(30) Foreign Application Priority Data
Mar. 18, 2011 (DE) 10 2011 005 766.8

(51) Int. Cl. G06F 7/00

(52) U.S. Cl. 701/1

(57) ABSTRACT

A control unit for a motor vehicle having a microprocessor that comprises at least two computation cores, a monitoring module that is separate from the microprocessor, an evaluation module for evaluating input signals provided by sensors, and an activation module comprising at least one end stage for producing output signals to activate actuators. A control function is implemented in a first computation core, a monitoring function for the first computation core of the microprocessor is implemented in the second computation core of the microprocessor, and a monitoring function for the second computation core of the microprocessor is implemented in the monitoring module. Starting from the first computation core and/or starting from the second computation core and/or starting from the monitoring module, a switch-off module can be activated to switch off the at least one end stage of the activation module.

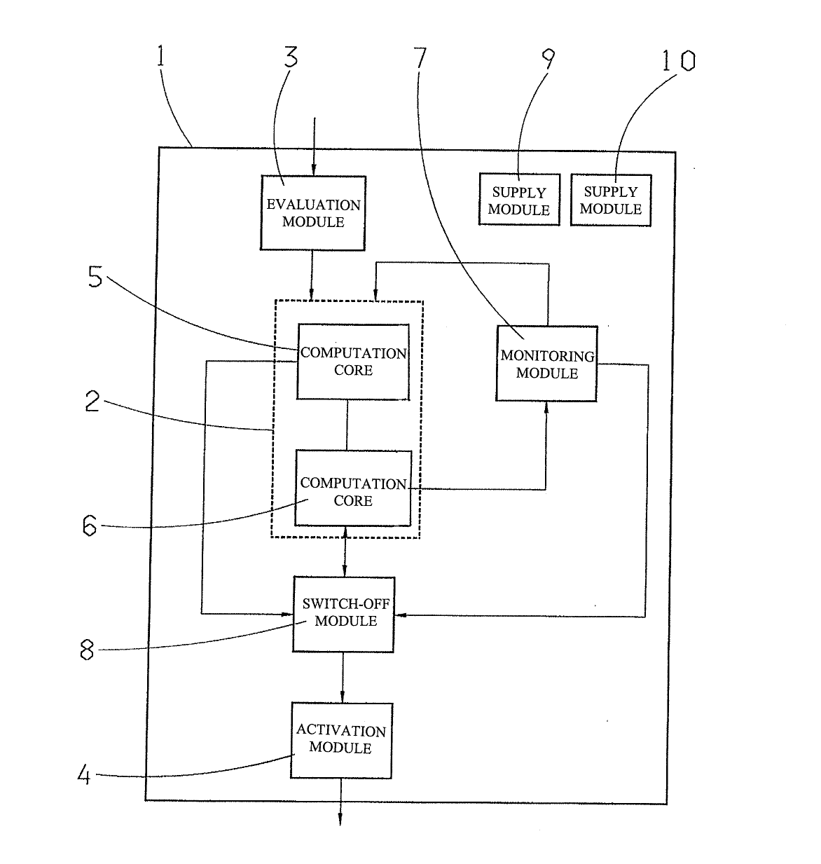

This application claims priority from German patent application serial no. 10 2011 005 766.8 filed Mar. 18, 2011.

### FIELD OF THE INVENTION

The invention concerns a control device for a motor vehicle, in particular a transmission control device of a vehicle transmission, for example an automatic transmission or an automated variable-speed transmission.

### BACKGROUND OF THE INVENTION

The basic structure of a control device for a motor vehicle is known from “Electronics in Vehicle Technology, Kai Bargeest, ATZ/MTZ Handbook, p. 85, 1^{st} Edition, 2008”. Thus, a control device comprises a microprocessor in which a control function of the control device is implemented, an evaluation module for evaluating input signals provided by sensors, and an activation module for activating actuators. The evaluation module provides appropriate data to the microprocessor and the microprocessor to the activation module. Furthermore, from this prior art it is already known that a control device comprises an electrical supply module in order to supply the control device with electric current or electric voltage.

From DE 10 2005 057 066 A1 a control device for a motor vehicle is known, which comprises at the least a primary microprocessor and if necessary a further, secondary microprocessor. According to this prior art the primary microprocessor has a primary control path and a redundant control path, the redundant control path enables the control device to operate at a more rapid processing speed. Furthermore, data verification can take place by way of the redundant control path of the primary microprocessor or by way of the secondary microprocessor.

In the event of a fault in the control device, to ensure the safety of the motor vehicle or of an assembly in the motor vehicle that is to be controlled or regulated by the control device, if the control device develops a fault, its activation module, namely the—or each—performance-determining end stage of the activation module, must be safely and reliably switched off. For this, for control devices whose microprocessors comprise a plurality of computation cores no suitable solution has been known before now.

### SUMMARY OF THE INVENTION

Starting from there, the purpose of the present invention is to provide a new type of control device for a motor vehicle.

The control device according to the invention has a microprocessor with at least two computation cores, a monitoring module separate from the microprocessor, an evaluation module for evaluating input signals provided in particular by sensors, and an activation module having at least one end stage for the production of output signals for activating actuators, such that a control function is implemented in a first computation core of the microprocessor, a monitoring function for the first computation core of the microprocessor is implemented in the second computation core of the microprocessor, a monitoring function for the second computation core of the microprocessor is implemented in the monitoring module, and such that starting from the first computation core of the microprocessor and/or starting from the second computation core of the microprocessor and/or starting from the monitoring module, a switch-off module can be activated in order to switch off the—or each—end stage of the activation module.

Thus, the control device according to the invention comprises a microprocessor with at least two computation cores and a monitoring module separate from the microprocessor, which is therefore not part of the microprocessor. A switch-off module of the control device according to the invention, which serves to switch off the—or each—end stage of the activating module, can be activated both starting from the first computation core, and starting from the second computation core, and also starting from the monitoring module. Thus, the two computation cores and the monitoring module, acting independently of one another, can activate the switch-off module in order, if a fault has been detected in the control device, to ensure a safe condition. The independent activation of the switch-off module starting from the first computation core of the microprocessor, starting from the second computation core of the microprocessor and starting from the monitoring module, which is not part of the microprocessor, enables a safe condition to be obtained regardless of whether one of the two computation cores of the microprocessor or the monitoring module has developed a fault. For safety reasons this is particularly preferred.

According to an advantageous further development the monitoring function of the second computation core of the microprocessor monitors the first computation core of the microprocessor, in that the second computation core on the one hand sends regular test requests to the first computation core and monitors their implementation, and on the other hand the second computation core copies the control function of the first computation core and compares signals of the control function of the first computation core with signals of the control function copied on the second computation core, and when the monitoring function of the second computation core of the microprocessor detects a faulty function of the first computation core of the microprocessor, the second computation core first specifies zero as the nominal value of the control function of the first computation core and if, despite the zero specified as the nominal value of the control function of the first computation core, the monitoring function of the second computation core still detects a faulty function of the first computation core, the second computation core activates the switch-off module. This graded reaction to a recognized faulty function of the first computation core of the microprocessor, in which the control function is implemented, is particularly preferred for control purposes. Thus, by virtue of the zero specification for the nominal value of the control function, it can be ensured that the action of the control device on the assembly of the motor vehicle to be controlled or regulated does not terminate abruptly, but rather, for example by means of a gradual zero specification for the nominal value, it can be diminished progressively. If during this a recognized functional defect disappears, the control function can be rapidly reinstated. Only when the functional defect persists despite the zero specification for the nominal value, is the switch-off module activated and thereby the—or each—end stage switched off.

According to another advantageous further development, the monitoring function of the monitoring module monitors the second computation core of the microprocessor in that the monitoring module monitors signals sent preferably regularly by the second computation core to the monitoring module, and if the monitoring function of the monitoring module detects a functional defect of the second computation core of the microprocessor, the monitoring module activates the switch-off module.

In order to monitor the second computation core, the monitoring module monitors signals sent preferably regularly by the second computation core to the monitoring module, the monitoring module can be in the form of a simple logic gate. This can check whether the frequency and/or length of signals sent by the second computation core to the monitoring module correspond to a specification, and in the event of a deviation a functional, defect of the second computation core is detected. If the second computation core, which provides the monitoring function for the first computation core and hence for the control function implemented in the first computation core, is affected by a functional defect, then the switch-off module is activated starting from the monitoring module and thus the—or each—end stage of the activation module is switched off.

In another advantageous further development the second computation core of the microprocessor or the first computation core of the microprocessor checks the monitoring module each time the control device is restarted, and if the second computation core of the microprocessor detects a functional defect in the monitoring module the second computation core activates the switch-off module, whereas if the first computation core of the microprocessor detects a functional defect in the monitoring module the first computation core activates the switch-off module. In this way the correct operation of the monitoring module separate from the microprocessor can be monitored and ensured.

A switch-off module that has been activated can only be deactivated if the first computation core of the microprocessor and the second computation core of the microprocessor and the monitoring module are all clear of any functional defect. This feature is particularly preferred for safety reasons.

Preferably, separate electrical supply modules are provided for the microprocessor and the monitoring module. The provision of independent electrical supply modules for the microprocessor and the monitoring module is particularly preferred.

If one electrical supply module should fail, then by virtue of the components of the control device supplied with electric current or electric voltage by the other electrical supply module, the switch-off module can still be activated in order to ensure a safe condition.

### BRIEF DESCRIPTION OF THE DRAWINGS

Preferred further developments of the invention emerge from the subordinate claims and from the description below. Example embodiments of the invention, to which it is not limited, are explained in more detail with reference to the sole drawing, which shows a block circuit diagram of a control device according to the invention for a motor vehicle.

### DETAILED DESCRIPTION OF THE PREFERRED EMBODIMENTS

The invention concerns a control device for a motor vehicle, with the help of which the operation of an assembly in the motor vehicle can be controlled and/or regulated. Thus, the control device according to the invention can be a transmission control device for controlling and/or regulating a vehicle transmission, in particular an automatic transmission or an automated variable-speed transmission with a plurality of selectable gear ratios. Alternatively, the control device of the invention can also be an engine control device for controlling/regulating an internal combustion engine or an electric motor, or a hybrid control device for controlling/regulating a hybrid vehicle drive-train, or some other control device of a motor vehicle, in particular a control device for windows, mirrors, seat adjustment, air-condition units, lighting or chassis, for controlling or regulating the corresponding components.

The sole FIGURE shows a block circuit diagram of a control device 1 according to the invention, the control device 1 of the sole FIGURE comprising a microprocessor 2, an evaluation module 3 and an activation module 4. The evaluation module 3 serves to evaluate input signals sent to the control device 1 preferably by sensors built into the motor vehicle, for example temperature, rotational speed and/or current/voltage sensors. The activation module 4 serves to produce or provide output signals for activating electric actuators built into the motor vehicle. Depending on the control device's area of use, such actuators serve in particular for the direct actuation, or indirectly to initiate the actuation, of a vehicle starting clutch, a transmission gearshift device, an engine control device, or a seat, mirror, air-conditioning, lighting, windows or chassis adjustment device. Thus, such an actuator can be, in particular, an electric motor (working rotationally or in translation) or an electromagnetically actuated hydraulic or pneumatic valve. For this, the activation module 4 comprises at least one performance-determining end stage.

The microprocessor 2 of the control device 1 according to the invention comprises at least two computation cores 5 and 6, the microprocessor 2 of the sole FIGURE being in particular designed as a multi-core microprocessor, for example a dual-core microprocessor. Thus, besides the computation cores 5 and 6, the microprocessor 2 can have as many further computation cores as desired.

In the first computation core 5 of the microprocessor 2 is implemented a control function by means of which the operation of an assembly of the motor vehicle is controlled and/or regulated. Thus, the control function implemented in the first computation core 5 of the microprocessor 2 can comprise control routines and regulation routines.

In the second computation core 6 of the microprocessor 2 is implemented a monitoring function for the first computation core 5. The monitoring function of the second computation core 6 of the microprocessor 2 monitors the first computation core 5, in that on the one hand the second computation core 6 regularly sends test requests to the first computation core 5 and monitors the way they are carried out, and on the other hand the second computation core 6 copies or mirrors the control function of the first computation core 5 and compares signals of the control function of the first computation core 5 with signals of the control function copied or mirrored by the second computation core 6.

By virtue of the regular test requests sent by the monitoring function of the second computation core 6 to the first computation core 5 and monitored, it is possible in particular to monitor at the first computation core 5 a set of instructions, storage range(s), periphery range(s), operating system(s), timer function(s) and interrupt function(s), without however being limited to these.

In addition to the microprocessor 2 with the two computation cores 5 and 6, the module 3 and the activation module 4, the control device 1 comprises a monitoring module 7 formed separately from the microprocessor. In the monitoring module 7 is implemented a monitoring function for the second computation core 6 of the microprocessor, so that the second computation core 6 can be monitored by the monitoring module 7 and therefore independently of the microprocessor 2. Preferably, the monitoring function of the monitoring module 7 monitors the second computation core 6 in that the monitoring module 7 monitors signals sent by the second computation core 6 to the monitoring module 7, in particular signals sent regularly, such as pulses at set times at a defined frequency and of a defined length.

Only if these sent signals conform with a specification are the second computation core 6 of the microprocessor 2, and hence the monitoring function implemented in it, operating as they should. In the event of a deviation, the monitoring module 7 recognizes a functional defect in the second computation core 6.

Each time the control device 1 is restarted the correct operation of the monitoring module 7 can be checked, and this either by the second computation core 6 of the microprocessor 2 or alternatively also by the first computation core 5 of the microprocessor 2. Preferably, each time the control device 1 is restarted the monitoring module 7 is checked by the monitoring function implemented in the second computation core 6 of the microprocessor 2.

If faulty functioning of the control device 1 is recognized, then according to the invention, starting from the first computation core 5 of the microprocessor 2 and/or starting from the second computation core 6 of the microprocessor 2 and/or starting from the monitoring module 7 and therefore from a component of the control device 1 which is independent of the microprocessor, a switch-off module 8 of the control device 1 is activated, so that by way of the switch-off module 8 the—or each—end stage of the activating module 4 is switched off.

Accordingly, the switch-off module 8 can be activated and the—or each—performance-determining end stage of the activation module 4 can therefore be switched off, not just by one of the computation cores of the microprocessor 2, but by both computation cores 5 and 6 of the microprocessor 2 and also by the monitoring module 7.

For safety reasons this is particularly preferred, since it can always be ensured that the control device can be brought to a safe condition, regardless of whether one of the two computation cores 5 and 6 or the monitoring module 7 has a defective function.

If the monitoring function of the second computation core 6 of the microprocessor 2 detects a functional defect in the first computation core 5 of the microprocessor 2, the switch-off module 8 can be activated by the second computation core 6. For this, the procedure adopted is in the manner of a degradation, i.e. the second computation core 6 first specifies zero as the nominal value of the control function of the first computation core 5, preferably in the sense of a gradual reduction of the nominal value of the control function to zero. In this way, in the manner of a gentle switching off, the action of the control device on the—or each—assembly of the motor vehicle to be operated by way of the control device is reduced gradually, with the advantage that the action of the control device is not terminated abruptly. Only if the monitoring function of the second computation core 6 still detects a faulty function in the first computation core 5 despite the zero specification for the nominal value of the control function of the first computation core 5, is the switch-off module 8 activated starting from the second computation core 6 such that the—or each—end stage of the control module 4 is switched off.

If the monitoring function of the monitoring module 7 detects a functional defect in the second computation core 6 of the microprocessor 2, the switch-off module 8 is activated starting from the monitoring module 7 and the—or each—end stage of the activation module 4 is switched off. If, when the control device 1 is restarted, faulty functioning of the monitoring module 7 is detected, then either the second computation core 6 or the first computation core 5 can activate the switch-off module 8, namely depending on which of the two computation cores 5 or 6 has detected the malfunctioning of the monitoring module 7.

When the control device 1 is restarted it is also preferable to be able to check all the activation possibilities of the switch-off module 8, namely in such manner that the first computation core 5 checks the activation possibilities of the switch-off module 8 starting from the second computation core 6, and the second computation core 6 checks the activation possibilities of the switch-off module 8 starting from the first computation core 5 and also starting from the monitoring module 7.

If the first computation core 5 detects that the activation of the switch-off module 8 starting from the second computation core 6 is incorrect, then the switch-off module 8 is activated starting from the first computation core 5 and the system is brought to a safe condition with the end stages of the activation module 4 switched off. On the other hand, if the second computation core 6 detects that the activation possibility of the switch-off module 8 starting from the first computation core 5 or starting from the monitoring module 7 is incorrect, then the switch-off module 8 is activated starting from the second computation core 6 and thus the—or each—end stage of the activation module 4 is switched off in order to obtain the safe condition.

When the control device is started or after a reaction to a defect, an activated switch-off module 8 can only be deactivated and thus the—or each—end stage of the activation module 4 can only be switched on, if both the first computation core 5 of the microprocessor 2 and the second computation core 6 of the microprocessor 2, and also the monitoring module 7 separate from the microprocessor 2, in each case detect no functional defects. If this is found, then during operation in the manner described above it is checked whether, during operation, a functional defect appears in the first computation core 5 or the second computation core 6 or the monitoring module 7, and if so, in the manner described above the switch-off module can be activated and the—or each—end stage of the activation module 4 can be switched off. When a defect or defective function is recognized and the—or each—end stage of the activation module 4 has accordingly been switched off, there can be a pause for a defined defect tolerance time before restarting of the control device 1 is attempted.

As shown in the sole FIGURE the control device 1 comprises two electrical supply modules 9 and 10. The supply module 9 serves to supply the microprocessor 2 with electric voltage or electric current. In contrast, the supply module 10 supplies electric voltage or electric current to the monitoring module 7. If one of the supply modules 9 or 10 should fail, by virtue of the still active supply module, reaching a safe condition can be ensured by switching off the—or each—end stage of the activation module 4 by correspondingly activating the switch-off module 8.

### INDEXES

1 Control device
2 Microprocessor
3 Evaluation module
4 Activation module
5 Computation core
6 Computation core
7 Monitoring module
8 Switch-off module
9 Supply module
10 Supply module

1-11. (canceled)

12. A control unit for a motor vehicle, the control unit comprising:
a microprocessor (2) comprising at least first and second computation cores (5, 6),
a monitoring module (7) being separated from the microprocessor (2),
an evaluation module (3) for evaluating input signals provided by sensors, and
an activation module (4) comprising at least one end stage for producing output signals for activating actuators,
such that:
a control function being implemented in the first computation core (5),
a monitoring function for the first computation core of the microprocessor being implemented in the second computation core (6) of the microprocessor,
a monitoring function for the second computation core of the microprocessor being implemented in the monitoring module (7), and
such that:
starting from at least one of the first computation core (5) of the microprocessor, the second computation core (6) of the microprocessor and the monitoring module (7), a switch-off module (8) being activated for switching off the at least one end stage of the activation module (4).

13. The control unit according to claim 12, wherein the monitoring function of the second computation core (6) of the microprocessor (2) monitors the first computation core (5) of the microprocessor (2),
the second computation core (6) sends regular test requests to the first computation core (5) and monitors how they are carried out, and
the second computation core (6) copies the control function of the first computation core (5) and compares signals of the control function of the first computation core (5) with signals of the control function copied in the second computation core (6).

14. The control unit according to claim 13, wherein if the monitoring function of the second computation core (6) of the microprocessor (2) detects a functional defect in the first computation core (5) of the microprocessor (2), the switch-off module (8) is activated starting from the second computation core (6).

15. The control unit according to claim 13, wherein if the monitoring function of the second computation core (6) of the microprocessor (2) detects a functional defect in the first computation core (5) of the microprocessor (2), the second computation core (6) first specifies zero as a nominal value of the control function of the first computation core, and if the monitoring function of the second computation core (6) still detects faulty functioning of the first computation core (5) despite the zero specification for the control function of the first computation core, then the second computation core (6) activates the switch-off module (8).

16. The control unit according to claim 12, wherein the monitoring function of the monitoring module (7) monitors the second computation core (6) of the microprocessor (2), and the monitoring module (7) monitors signals sent to the monitoring module (7) by the second computation core (6).

17. The control unit according to claim 16, wherein if the monitoring function of the monitoring module (7) detects faulty functioning of the second computation core (6) of the microprocessor (2), the monitoring module (7) activates the switch-off module (8).

18. The control unit according to claim 12, wherein each time the control unit is restarted, either the second computation core (6) of the microprocessor (2) or the first computation core (5) of the microprocessor (2) checks the monitoring module (7).

19. The control unit according to claim 18, wherein either the second computation core (6) activates the switch-off module (8), if the second computation core (6) of the microprocessor (2) detects a functional defect in the monitoring module (7), or the first computation core (5) activates the switch-off module (8), if the first computation core (5) of the microprocessor (2) detects a functional defect in the monitoring module (7).

20. The control unit according to claim 18, wherein each time the control unit is restarted, all activation possibilities of the switch-off module (8) are checked such that the first computation core (5) checks the activation possibilities of the switch-off module (8) starting from the second computation core (6), and if during this the first computation core (5) detects a faulty function, the switch-off module (8) is activated starting from the first computation core (5), and the second computation core (6) checks the activation possibilities of the switch-off module (8) starting from the first computation core (5) and starting from the monitoring module (7), and if during this the second computation core (6) detects a faulty function, the switch-off module is activated starting from the second computation core (6).

21. The control unit according to claim 12, wherein an activated switch-off module (8) is only deactivated when neither the first computation core (5) of the microprocessor, nor the second computation core (6) of the microprocessor, nor the monitoring module (7) detect any faulty function.

22. The control unit according to claim 12, wherein a first electrical supply module (9) supplies energy to the microprocessor (2) and a second electrical supply module (10) supplies energy to the monitoring module (7).

23. A control unit for a motor vehicle, the control unit comprising:
an evaluation module (3) for receiving and evaluating input signals transmitted by sensors;
a microprocessor (2) for directly communicating with the evaluation module (3) and comprising at least first and second computation cores (5, 6), the first computation core (5) facilitating initiation of a control function for controlling operation of an assembly of the motor vehicle, the second computation core (6) being directly associated with and monitoring functioning of the first computation core (5);
a monitoring module (7) being independent from the microprocessor (2), and the monitoring module (7) being directly associated with and monitoring functioning of the second computation core (6), and the first computation core (5) being associated with and monitoring functioning of the monitoring module (7);
a switch-off module (8) directly communicating with each of the first and the second computation cores (5, 6) and the monitoring module (7);
an activation module (4) comprising at least one end stage for producing and transmitting output signals for actuating actuators, the activation module (4) directly communicating with the switch-off module (8) and the switch-off module (8) switches off the at least one end stage of the activation module (4) when the functioning of one of the first computation core (5), the second computation core (6), and the monitoring module (7) is determined to be faulty by a respectively associated one of the first computation core (5), the second computation core (6), and the monitoring module (7).
